(19) United States
(12) Patent Application Publication
(10) Pub. No.: US 2014/0085272 A1
(43) Pub. Date: Mar. 27, 2014

(54) PROJECTOR SYSTEM AND CONTROL METHOD FOR THE PROJECTOR SYSTEM

(71) Applicant: SEIKO EPSON CORPORATION, Tokyo (JP)

(72) Inventor: Takashi OZAWA, Shiojiri-Shi (JP)

(73) Assignee: SEIKO EPSON CORPORATION, Tokyo (JP)

(21) Appl. No.: 14/036,800

(22) Filed: Sep. 25, 2013

(30) Foreign Application Priority Data
Sep. 27, 2012 (JP) 2012-213720

(51) Int. Cl. G06F 3/0354

(52) U.S. Cl. CPC G06F 3/03545
USPC 345/179

(57) ABSTRACT

A projector system including input pens, the projector system being capable of preventing a user from forgetting to return the input pen to a predetermined place after using the input pen is provided. When the projector system receives power-off operation during an operation, if at least one of the input pens is not stored in a pen housing unit, a warning message is projected by an image projecting unit. If all the input pens are housed in the pen housing unit, a power supply for the projector system is turned off.

### CROSS-REFERENCE TO RELATED APPLICATION

The entire disclosure of Japanese Patent Application No. 2012-213720, filed Sep. 27, 2012 is expressly incorporated by reference herein.

### BACKGROUND

1. Technical Field

The present invention relates to a projector system that projects an image and a control method for the projector system.

2. Related Art

In a class at a school or the like, when using a projector, for explanation, a teacher sometimes desires to write characters and figures in a projection image. In this case, there is a method of operating a pointing device such as a mouse on a screen of a personal computer (PC), to which image data is input, to input characters and figures. Besides, in recent years, for example, JP-A-2011-140154 (Patent Literature 1) discloses an apparatus in which a user operates a pen-type input device on an image projected on a screen to write characters and figures.

However, in the projector disclosed in Patent Literature 1, since the user separately handles the projector and the pen-type input device, it is likely that the user forgets to return the pen-type input device to an original place after finishing using the projector and loses the pen-type input device.

### SUMMARY

An advantage of some aspects of the invention is to solve at least a part of the problems described above, and the invention can be implemented as the following forms or application examples.

### Application Example 1

This application example is directed to a projector system including: a projector including an image projecting unit configured to project an image; one or more input pens; and a pen holder configured to house the input pens. The pen holder includes: a pen detecting unit configured to detect whether the input pens are housed; and a control unit configured to control the projector system. When the projector system receives power-off operation, the control unit defers power-off until the pen detecting unit detects that all the input pens are housed in the pen holder.

According to this application example, when the projector system receives power-off operation, the control unit defers power-off until all the input pens are housed in the pen holder. Consequently, it is possible to urge a user to return the input pens to the pen holder after finishing using the projector. Therefore, it is possible to prevent a power supply for the projector system from being turned off in a state in which the input pens are not housed in the pen holder.

### Application Example 2

This application example is directed to the projector system according to the application example described above, wherein the control unit turns on a power supply for the projector when the projector system detects, with the pen detecting unit, that at least one of the input pens is taken out from the pen holder.

According to this application example, the projector system is turned on when the user takes out at least one of the input pens from the pen holder. Therefore, in using the projector system, the user only has to take out the input pen. It is possible to omit power-on operation.

### Application Example 3

This application example is directed to the projector system according to the application example described above, wherein the pen holder further includes: an input operation unit configured to receive input operation; and a pen lock mechanism configured to prevent the input pen from being taken out from the pen holder. When the input operation unit receives predetermined lock operation or unlock operation, the control unit sets the pen lock mechanism in a lock state or an unlock state.

According to this application example, it is possible to lock take-out of the input pen from the pen holder with the predetermined lock operation. Therefore, it is possible to prevent the input pen from being dishonestly carried out from the pen holder.

### Application Example 4

This application example is directed to the projector system according to application example described above, wherein the pen holder further includes an informing unit configured to inform, if the projector system detects, with the pen detecting unit, that at least one of the input pens is not housed in the pen holder when the projector system receives the power-off operation, a user to that effect.

According to this application example, if at least one of the input pens is not housed in the pen holder when the projector system receives the power-off operation, the projector system informs the user to that effect with the informing unit included in the pen holder. Therefore, it is possible to urge the user to house the input pen in the pen holder.

### Application Example 5

This application example is directed to a control method for a projector system including: a projector including an image projecting unit configured to project an image; one or more input pens; and a pen holder configured to house the input pens. The control method includes: a pen detecting step of the pen holder detecting whether the input pens are housed; and a control step of the pen holder deferring, when the projector receives power-off operation, power-off until it is detected in the pen detecting step that all the input pens are housed in the pen holder.

According to this application example, when the projector system receives power-off operation, power-off is deferred until all the input pens are housed in the pen holder. Consequently, it is possible to urge a user to return the input pens to the pen holder after finishing using the projector. Therefore, it is possible to prevent a power supply for the projector system from being turned off in a state in which the input pen is not housed in the pen holder.

### BRIEF DESCRIPTION OF THE DRAWINGS

The invention will be described with reference to the accompanying drawings, wherein like numbers reference like elements.

FIG. 1 is a diagram showing a setting state of a projector system.

FIG. 2 is a perspective view of a pen holder.

FIG. 3 is a block diagram showing a circuit configuration of the projector system.

FIGS. 4A to 4C are flowcharts for explaining the operation of the projector system, wherein FIG. 4A is a flowchart for explaining the operation performed when the projector system detects power-off operation, FIG. 4B is a flowchart for explaining the operation performed when the projector system detects that an input pen is taken out while the projector system is on standby, and FIG. 4C is a flowchart for explaining the operation performed when the projector system detects lock or unlock operation of the input pen.

FIG. 5 is a diagram showing a warming message.

### DESCRIPTION OF EXEMPLARY EMBODIMENTS

An embodiment of the invention is explained below with reference to the drawings. However, the embodiment explained below does not limit the invention described in the appended claims. All combinations of characteristics in the embodiment are not always essential for solutions of the invention.

### Embodiment

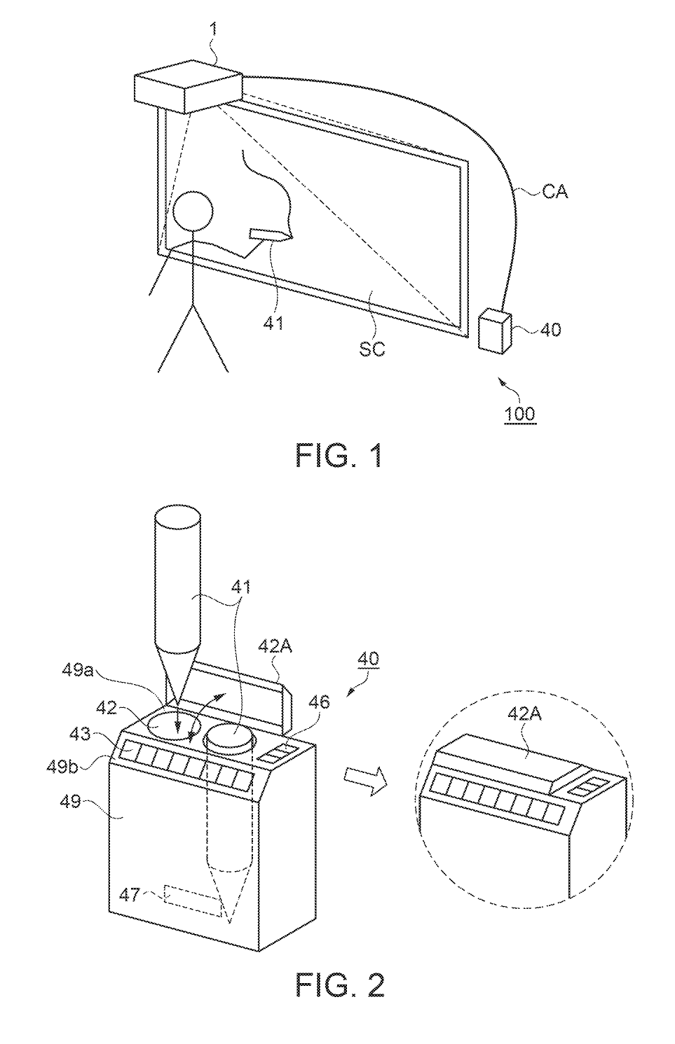

FIG. 1 is a diagram showing a setting state of a projector system 100 in this embodiment.

As shown in FIG. 1, the projector system 100 includes a projector 1, an input pen 41, and a pen holder 40.

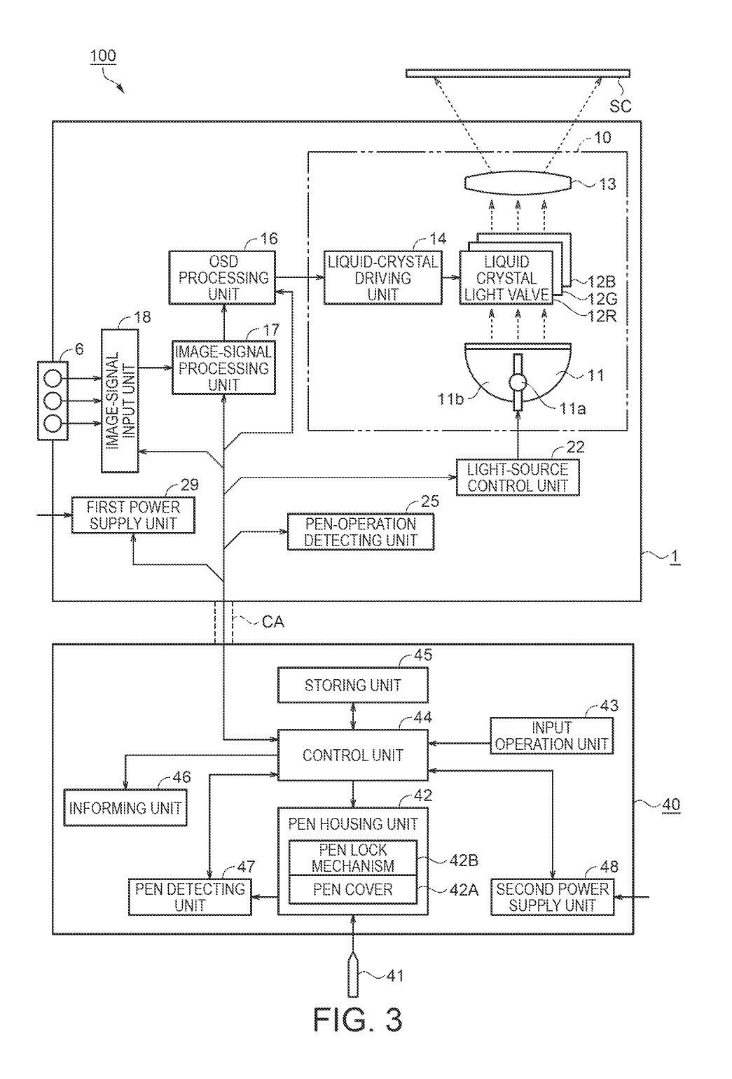

When a user performs rendering operation using the input pen 41 on a projection surface of a screen SC on which the projector 1 projects an image (a projection image), a pen-operation detecting unit 25 (see FIG. 3) of the projector 1 detects an operation track of the input pen 41. The projector 1 superimposes the detected operation track of the input pen 41 on the present projection image and projects the operation track on the projection surface of the screen SC.

The projector 1 and the pen holder 40 are connected by radio or via a cable CA and can communicate with each other.

FIG. 3 is a block diagram showing a circuit configuration of the projector system 100 in this embodiment.

As shown in FIG. 3, the projector system 100 includes the projector 1, the pen holder 40, and the input pen 41.

The projector 1 includes an image input terminal 6, an image projecting unit 10, an OSD processing unit 16, an image-signal processing unit 17, an image-signal input unit 18, a light-source control unit 22, a pen-operation detecting unit 25, and a first power supply unit 29. These units are housed on the inside or the outer surface of a housing of the projector 1.

The pen holder 40 includes a control unit 44, a storing unit 45, an informing unit 46, a pen housing unit 42, an input operation unit 43, a pen detecting unit 47, and a second power supply unit 48. These units are housed on the outer surface and the inside of a housing of the pen holder 40.

FIG. 2 is a perspective view of the pen holder 40. As shown in FIG. 2, in the pen holder 40, the pen housing unit 42 configured to house the input pen 41 is provided on an upper surface 49a of a housing 49. A plurality of the input pens 41 can be inserted and housed in the pen housing unit 42. A pen cover 42A that can cover the pen housing unit 42 and the informing unit 46 configured to inform a state of the projector system 100 are provided near the pen housing unit 42. The pen cover 42A can be locked in a state in which the pen cover 42A is closed by a not-shown pen lock mechanism 42B. The input pen 41 cannot be taken out in a state in which the pen cover 42A is locked by the pen lock mechanism 42B.

An input operation unit 43 configured to receive input operation is provided on a surface 49b adjacent to the upper surface 49a of the housing 49 of the pen holder 40. The pen detecting unit 47 configured to detect a housing state of the input pen 41 is provided on the inside of the housing 49 of the pen holder 40 and near the pen housing unit 42.

As shown in FIG. 3, the projector 1 and the pen holder 40 are connected via the cable CA. Various control signals are input from the pen holder 40 to the projector 1. Various state signals are input from the projector 1 to the pen holder 40.

Specifically, controls signals are input from the control unit 44 of the pen holder 40 to the image-signal input unit 18, the image-signal processing unit 17, the OSD processing unit 16, the light-source control unit 22, and the first power supply unit 29 of the projector 1. Pen operation information is input from the pen-operation detecting unit 25 of the projector 1 to the control unit 44 of the pen holder 40.

The image projecting unit 10 includes a light source 11, three liquid crystal light valves 12 (12R, 12G, and 12B) functioning as light modulation devices, a projection lens 13 functioning as a projection optical system, and a liquid-crystal driving unit 14. The image projecting unit 10 modulates light emitted from the light source 11 in the liquid crystal light valves 12R, 12G, and 12B and projects the light from the projection lens 13 to thereby display an image on the screen SC or the like functioning as a projection surface.

The light source 11 includes a light source lamp 11a of a discharge type configured by an extra-high pressure mercury lamp, a metal halide lamp, or the like and a reflector 11b configured to reflect the light emitted by the light source lamp 11a to the liquid crystal light valves 12R, 12G, and 12B side.

The light emitted from the light source 11 is converted into light having a substantially uniform luminance distribution by a not-shown integrator optical system, separated into respective color light components of red (R), green (G), and blue (B), which are the three primary colors of light, by a not-shown color separation optical system, and then respectively made incident on the liquid crystal light valves 12R, 12G, and 12B.

The liquid crystal light valves 12R, 12G, and 12B are configured by, for example, a liquid crystal panel in which liquid crystal is encapsulated between a pair of transparent substrates. A plurality of pixels (not shown in the figure) arrayed in a matrix shape are formed on the liquid crystal light valves 12R, 12G, and 12B. A driving voltage can be applied to the liquid crystal for each of the pixels.

When the liquid-crystal driving unit 14 applies a driving voltage corresponding to input image information to the pixels, the pixels are set to light transmittance corresponding to the image information. Therefore, the light emitted from the light source 11 is modulated by being transmitted through the liquid crystal light valves 12R, 12G, and 12B. Image light corresponding to the image information is formed for each of color lights.

Formed image lights of the colors are combined for each of the pixels by a not-shown color combination optical system to be color image light and, then, enlarged and projected on the screen SC or the like by the projection lens 13.

In this embodiment, the projector system 100 that projects an image using the light source lamp 11a as the light source 11 is illustrated. However, the invention can also be applied to a projector system that projects an image using an LED (Light Emitting Diode) light source, a laser light source, or the like as the light source.

In this embodiment, as the image projecting unit 10, the projection optical system of the transmission liquid crystal system including the three liquid crystal light valves 12R, 12G, and 12B as the light modulating devices is illustrated. However, light modulation devices of other display systems such as a reflection liquid crystal display system and a micro-mirror device system (a last switch display system) may be adopted.

Image information is input to the image-signal input unit 18 through a plurality of the image input terminals 6 from an external image output apparatus such as a video reproduction apparatus or a personal computer via a not-shown cable, communication apparatus, or the like. The input image information is output to the image-signal processing unit 17 on the basis of an instruction of the control unit 44.

In this embodiment, the image input terminals 6 and the image-signal input unit 18 are provided in the projector 1. However, the image input terminals 6 and the image-signal input unit 18 may be provided on the pen holder 40 side to supply image information from the pen holder 40 to the projector 1 via the cable CA.

The image-signal processing unit 17 converts the image information input from the image-signal input unit 18 into image information representing gradations of the pixels of the liquid crystal light valves 12R, 12G, and 12B. The converted image information is image information by color lights of red (R), green (G), and blue (B). The image information includes a plurality of pixel values corresponding to all the pixels of the liquid crystal light valves 12R, 12G, and 12B. The pixel values specify light transmittances of the pixels corresponding thereto. Intensities (gradations) of lights transmitted through the pixels and emitted are specified by the pixel values.

The OSD processing unit 16 performs, based on an instruction of the control unit 44, processing for superimposing an OSD (on screen display) image such as a menu image or a message image on a projection image and displaying the OSD image. The OSD processing unit 16 includes a not-shown OSD memory and has stored therein OSD image information representing a figure, a font, and the like for forming an OSD image.

When the control unit 44 instructs superimposed display of the OSD image, the OSD processing unit 16 reads out necessary OSD image information from the OSD memory and combines the OSD image information with the image information, which is input from the image-signal processing unit 17, such that the OSD image is superimposed on a predetermined position of a projection image. The image information combined with the OSD image information is output to the liquid-crystal driving unit 14.

When an instruction for superimposing the OSD image is not received from the control unit 44, the OSD processing unit 16 directly outputs the image information input from the image-signal processing unit 17 to the liquid-crystal driving unit 14.

When the liquid-crystal driving unit 14 drives the liquid crystal light valves 12R, 12G, and 12B according to the image information input from the OSD processing unit 16, the liquid crystal light valves 12R, 12G, and 12B form an image (a projection image) corresponding to the image information. The image is projected from the projection lens 13.

The light-source control unit 22 controls supply of electric power to the light source 11 and stop of the supply of the electric power on the basis of an instruction of the control unit 44 and switches lighting and extinguishing of the light source 11.

The pen-operation detecting unit 25 is configured by a not-shown image pickup device or the like. The pen-operation detecting unit 25 detects the position of the input pen 41 and a depression state of a pen tip switch (not shown in the figure) and notifies the control unit 44 of pen operation information of the input pen 41 on the basis of an instruction of the control unit 44.

Electric power of AC 100 V or the like is supplied to the first power supply unit 29 from the outside via a not-shown power supply terminal. The first power supply unit 29 converts the input electric power (alternating-current electric power) into predetermined direct-current electric power and supplies the electric power to the units of the projector 1.

The first power supply unit 29 can switch, on the basis of an instruction of the control unit 44, a state in which electric power necessary for the operation of the projector 1 (operation electric power) is supplied to the units (a power-on state) and a state in which the supply of the operation electric power is stopped to put operation for turning on the power supply on standby (a standby state).

The control unit 44 includes a CPU (Central Processing Unit) and a RAM (Random Access Memory) used for temporary storage of various data and the like. The control unit 44 operates according to a control program (not shown in the figure) stored in the storing unit 45 to thereby collectively control the operation of the projector system 100. That is, the control unit 44 functions as a computer together with the storing unit 45.

The storing unit 45 is configured by a rewritable nonvolatile memory such as a flash memory or an FeRAM. A control program for controlling the operation of the projector system 100, various setting data specifying operation conditions and the like of the projector system 100, and the like are stored in the storing unit 45.

The informing unit 46 is configured by an LED, a buzzer, or the like. The informing unit 46 informs the user of various operation states of the projector system 100 according to an instruction from the control unit 44. In this embodiment, when the projector system 100 receives power-off operation, the informing unit 46 informs the user of a state in which at least one input pen 41 is not housed in the pen housing unit 42.

The input operation unit 43 includes a plurality of operation keys for the user to give various instructions to the projector system 100. As the operation keys included in the input operation unit 43, there are, for example, a power key for alternately switching ON and OFF of the power supply, an input switching key for switching the plurality of image input terminals 6, a menu key for superimposing and displaying a setting menu and the like, direction keys (four operation keys corresponding to up and down and the left and the right) used in selection of an item in the setting menu and the like, a determination key for determining the selected item, a cancel key for performing cancellation of operation or the like, and number keys for locking or unlocking the pen cover 42A using the pen lock mechanism 42B.

When the user operates any one of the various operation keys of the input operation unit 43, the input operation unit 43 outputs an operation signal corresponding to operation contents of the user to the control unit 44. The input operation unit 43 may include a remote-controller-signal receiving unit (not shown in the figure) and a remote controller (not shown in the figure) that can be remotely operated.

In this case, the remote controller transmits an operation signal of an infrared ray or the like corresponding to the operation contents of the user. The remote-controller-signal receiving unit receives the operation signal and communicates the operation signal to the control unit 44 as control information.

The pen housing unit 42 includes the pen cover 42A (see FIG. 2) configured to cover the input pen 41 after housing and the pen lock mechanism 42B configured to lock opening and closing of the pen cover 42A.

The pen lock mechanism 42B is configured by a solenoid, a motor, a gear mechanism, or the like. The pen lock mechanism 42B operates according to the control from the control unit 44 and sets the pen cover 42A in a lock state in which the pen cover 42A is retained in a closed position and an unlock state in which the retention of the pen cover 42A is released to allow the pen cover 42A to open and close. The lock state and the unlock state of the pen lock mechanism 42B are switched by operation performed by, for example, a number key input of the input operation unit 43.

The pen lock mechanism 42B in this embodiment is configured to lock the pen cover 42A. However, the pen lock mechanism 42B only has to be capable of preventing the input pen 41 from being taken out from the pen holder 40. The pen lock mechanism 42B may be, for example, a pen lock mechanism configured to lock the input pen 41 itself.

The pen detecting unit 47 is configured by an optical sensor, a mechanical switch, or the like. The pen detecting unit 47 notifies the control unit 44 of a detection result concerning whether the input pen 41 is housed in the pen housing unit 42. When a plurality of the input pens 41 are housed in the pen housing unit 42, housing states of the respective input pens 41 are detected.

Electric power of AC 100 V or the like is supplied to the second power supply unit 48 from the outside via a not-shown power supply terminal. The second power supply unit 48 converts input electric power (alternating-current electric power) into predetermined direct-current electric power and supplies the electric power to the units of the pen holder 40.

The second power supply unit 48 can switch, on the basis of an instruction of the control unit 44, a state in which electric power necessary for the operation of the pen holder 40 (operation electric power) is supplied to the units (a power-on state) and a state in which the supply of the operation electric power is stopped to put operation for turning on the power supply on standby (a standby state). The control unit 44 instructs the second power supply unit 48 and the first power supply unit 29 to switch the projector system 100 to the power-on state or the standby state.

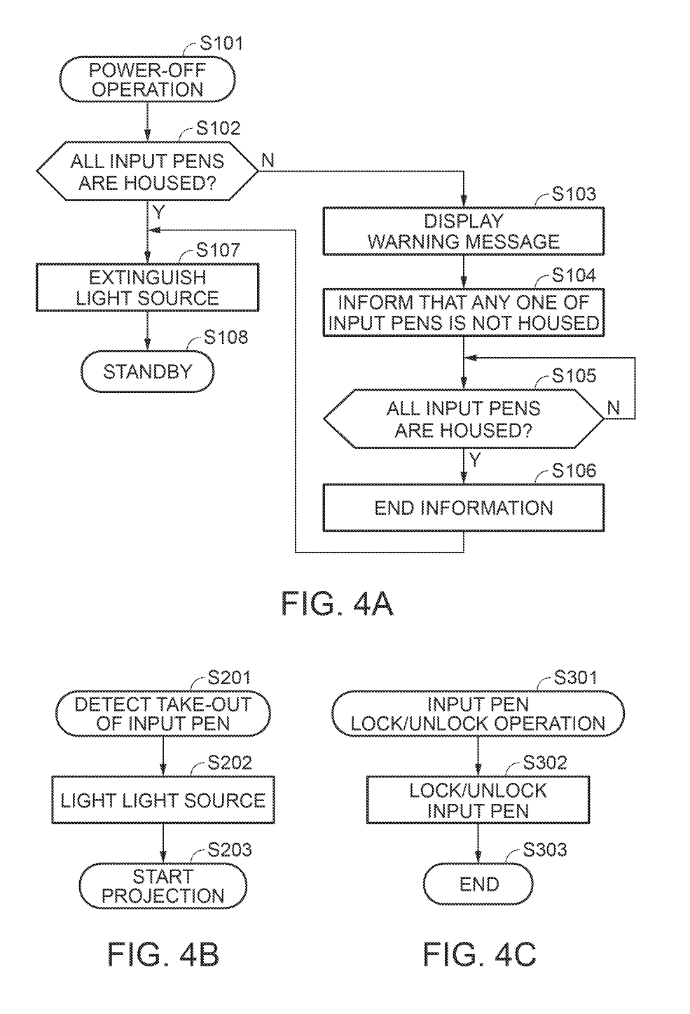

The operation of the projector system in this embodiment is explained with reference to flowcharts of FIGS. 4A to 4C. FIG. 4A is a flowchart for explaining the operation performed when the projector system 100 detects power-off operation during the operation. FIG. 4B is a flowchart for explaining the operation performed when the projector system 100 detects that the input pen 41 is taken out from the pen holder 40 while the projector system 100 is on standby. FIG. 4C is a flowchart for explaining the operation performed when the projector system 100 detects lock or unlock operation of the input pen 41.

### When the Projector System 100 Detects Power-Off Operation

As shown n FIG. 4A, while the projector system 100 is operating, when the projector system 100 detects and receives power-off operation through a power key or the like of the input operation unit 43 (step S101), the control unit 44 transitions to step S102.

In step S102, the control unit 44 acquires a housing state of the input pen 41 from the pen detecting unit 47 and checks whether all the input pens 41 are stored in the pen housing unit 42 (step S102). When all the input pens 41 are housed in the pen housing unit 42 (Y in step S102), the control unit 44 transitions to step S107. When any one of the input pens 41 is not housed in the pen housing unit 42 (N in step S102), the control unit 44 transitions to step S103. Step S102 and step S105 explained below are equivalent to the pen detecting step.

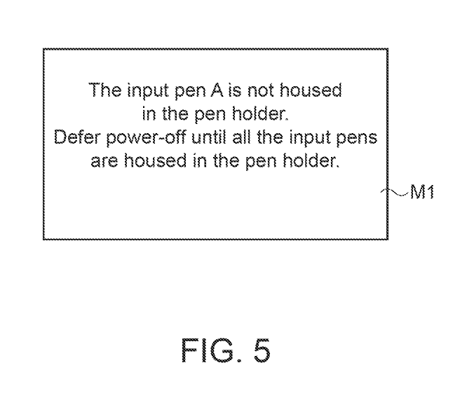

In step S103, the control unit 44 projects, with the image projecting unit 10, a warning message Ml indicating that any one of the input pens 41 is not housed in the pen housing unit 42 and transitions to step S104. The warning message Ml at this point is shown in FIG. 5.

In step S104, the control unit 44 causes the informing unit 46 to inform the user that any one of the input pens 41 is not housed in the pen housing unit 42 and transitions to step S105.

In step S 105, the control unit 44 acquires a housing state of the input pen 41 from the pen detecting unit 47 and checks whether all the input pens 41 are housed in the pen housing unit 42 (step S105). When all the input pens 41 are housed in the pen housing unit 42 (Y in step S105), the control unit 44 transitions to step S106. When any one of the input pens 41 is not housed in the pen housing unit 42 (N in step S105), the control unit 44 repeats step S105. Steps S103, S104, and S105 are equivalent to the control step. When the housing state of the input pens 41 changes (e.g., when only a pen A is housed in a state in which the pen A and a pen B are not housed), the control unit 44 may change a display message of the warning message M1.

In step S106, the control unit 44 causes the informing unit 46 to end the information and transitions to step S107.

In step S107, the control unit 44 causes the light-source control unit 22 to extinguish the light source 11 and transitions to step S108.

In step S108, the control unit 44 turns off the power supply for the projector system 100, shifts the power supply to the standby state, and ends the operation flow.

In steps S102 and S105, “all the input pens 41” may be the number of the input pens 41 that fill the entire pen housing unit 42 or may be specified as the number of the input pens 41 that fill a part of the pen housing unit 42.

When the Projector System 100 Detects that the Input Pen is Taken Out in the Standby State

As shown in FIG. 4B, in the standby state of the projector system 100, when the projector system 100 detects, with the pen detecting unit 47, that any one of the input pens 41 is taken out from the pen housing unit 42 (step S201), the control unit 44 transitions to step S202.

In step S202, the control unit 44 causes the light-source control unit 22 to light the light source 11 and transitions to step S203.

In step S203, the control unit 44 causes the image projecting unit 10 project image information input to the image-signal input unit 18 and ends the operation flow.

### When the Projector System 100 Detects Lock or Unlock Operation of the Input Pen

As shown in FIG. 4C, when the projector system 100 detects lock operation or unlock operation of the pen lock mechanism 42B by the input operation unit 43 (step S301), the control unit 44 transitions to step S302.

In step S302, the control unit 44 instructs the pen lock mechanism 42B to set the pen cover 42A in the lock state or the unlock state and transitions to step S303.

In step S303, the control unit 44 ends the operation flow.

As explained above, with the projector system 100 in this embodiment, when the projector 100 receives power-off operation, the control unit 44 defers power-off until all the input pens 41 are housed in the pen holder 40. Consequently, it is possible to urge the user to return all the input pens 41 to the pen holder 40 after finishing using the projector system 100. Therefore, it is possible to prevent the power supply for the projector system 100 from being turned off in a state in which the input pens 41 are not housed in the pen holder 40.

The projector system 100 is turned on when the user takes out any one of the input pens 41 from the pen holder 40. Therefore, in using the projector system 100, the user only has to take out the input pen 41. It is possible to omit power-on operation.

It is possible to lock take-out of the input pen 41 from the pen holder 40 with the predetermined lock operation. Therefore, it is possible to prevent the input pen 41 from being dishonestly carried out from the pen holder 40.

If any one of the input pens 41 is not housed in the pen housing unit 42 when the projector system 100 receives the power-off operation, the projector system 100 informs the user to that effect with the informing unit 46. Therefore, it is possible to urge the user to house the input pen 41 in the pen housing unit 42.

This embodiment may be changed as explained below.

### Modification

In the embodiment, after the input pen 41 is taken out from the pen holder 40 to turn on the power supply for the projector system 100 and use the projector system 100, the power supply for the projector system 100 may be turned off by housing the input pen 41 in the pen holder 40 again. Consequently, it is possible to turn on and off the projector system 100 only by taking out and housing the input pen 41.

What is claimed is:

1. A projector system comprising:
a projector including an image projecting unit configured to project an image;
one or more input pens; and
a pen holder configured to house the input pens, wherein
the pen holder includes:
a pen detecting unit configured to detect whether the input pens are housed; and
a control unit configured to control the projector system, and
when the projector system receives power-off operation, the control unit defers power-off until the pen detecting unit detects that all the input pens are housed in the pen holder.

2. The projector system according to claim 1, wherein the control unit turns on a power supply for the projector when the projector system detects, with the pen detecting unit, that at least one of the input pens is taken out from the pen holder.

3. The projector system according to claim 1, wherein
the pen holder further includes:
an input operation unit configured to receive input operation; and
a pen lock mechanism configured to prevent the input pen from being taken out from the pen holder, and
when the input operation unit receives predetermined lock operation or unlock operation, the control unit sets the pen lock mechanism in a lock state or an unlock state.

4. The projector system according to claim 1, wherein the pen holder further includes an informing unit configured to inform, if the projector system detects, with the pen detecting unit, that at least one of the input pens is not housed in the pen holder when the projector system receives the power-off operation, a user to that effect.

5. A control method for a projector system including: a projector including an image projecting unit configured to project an image; one or more input pens; and a pen holder configured to house the input pens,
the control method comprising:
the pen holder detecting whether the input pens are housed; and
the pen holder deferring, when the projector receives power-off operation, power-off until it is detected that all the input pens are housed in the pen holder.
